(19) United States
(12) Patent Application Publication
(10) Pub. No.: US 2016/0076231 A1
(43) Pub. Date: Mar. 17, 2016

(54) METHOD AND SYSTEM FOR MANAGING THE OPERATION OF A SHOWER

(71) Applicants: Aakash Kumar Goel, Thornhill (CA); Kramay Vipulbhai Patel, Woodbridge (CA)

(72) Inventors: Aakash Kumar Goel, Thornhill (CA); Kramay Vipulbhai Patel, Woodbridge (CA)

(21) Appl. No.: 14/851,648

(22) Filed: Sep. 11, 2015

Related U.S. Application Data
(60) Provisional application No. 62/049,038, filed on Sep. 11, 2014.

(51) Int. Cl. E03C 1/05; G05D 7/06; E03C 1/04

(52) U.S. Cl. CPC E03C 1/055; E03C 1/0408; G05D 7/0635; E03C 2001/026

(57) ABSTRACT

A method and system are provided for managing the operation of a shower. The method and system involve receiving user input through at least one input channel and optionally generating a first indication comprising at least one of an audio and visual indication at a user interface module, optionally executing at least one of a plurality of flow control instructions at a flow control module, and providing and configuring a processor to receive the user input, process the user input and generate a plurality of operational parameters, receive sensor data from the at least one of a plurality of sensors, store the sensor data at the storage module, transmit and receive information to and from external communication devices via a system network, determine, based on this information, the sensor data and the operational parameters whether a second indication and new flow control instructions are needed, and if so, causing the user interface module to optionally generate the second indication comprising at least one of an audio and visual indication, and if necessary, sending the new flow control instructions to the flow control module.

### FIELD

The embodiments described herein relate to methods and systems for managing the operation of a shower.

### BACKGROUND

Showerheads, faucets, and plumbing valves are all common plumbing devices installed as part of a system to distribute water in buildings. Existing showerheads and faucets have evolved to provide increased flexibility and manual control to the user. From bathroom sinks consisting of separate hot and cold water taps providing constant water flow rate to single handle faucets or showerhead assemblies that provide a user the ability to adjust water temperature and water flow, bathroom fixtures have evolved.

Existing showerheads and faucets distribute water to the user. From the time that water exits a showerhead or faucet, user input is necessary to control many variables such as whether water is to flow, flow rate, water temperature, or duration of water flow. Although existing showerhead and faucet devices generally provide the user with functional control of a showerhead or faucet, existing showerhead and faucet devices generally do not have the capacity to make decisions independent of user input, and are very limited in the ways in which they receive user input and provide information to the user.

### SUMMARY

In one aspect, in at least one embodiment described herein, there is provided a method for managing the operation of a shower. The method comprises receiving user input at a user interface module through at least one input channel and optionally generating a first indication comprising at least one of an audio and visual indications; executing at least one of a plurality of flow control instructions at a flow control module; providing and configuring, a processor, operatively coupled to the user interface module, the flow control module, at least one of a plurality of sensors, and a storage module, to: receive the user input from the user interface module; process the user input and generate a plurality of operational parameters; receive sensor data from the at least one of a plurality of sensors; store the sensor data at the storage module; determine based on the sensor data and the operational parameters whether a second indication is needed, and if so, causing the user interface module to optionally generate the second indication comprising at least one of an audio and visual indications; and determine based on the sensor data and the operational parameters whether new flow control instructions need to be performed, and if so, sending the new flow control instructions to the flow control module.

In another aspect, in at least one embodiment described herein, there is provided a system for managing the operation of a shower. The system comprises a user interface module to receive user input through at least one input channel and optionally generate a first indication comprising at least one of an audio and visual indication; a flow control module to execute at least one of a plurality of flow control instructions; a processor, operatively coupled to the user interface module, the flow control module, at least one of a plurality of sensors, and a storage module, configured to: receive the user input from the user interface module; process the user input and generate a plurality of operational parameters: receive sensor data from the at least one of a plurality of sensors; store sensor data at the storage module; determine based on the sensor data and the operational parameters whether a second indication is needed, and if so, causing the user interface module to optionally display the second indication comprising at least one of an audio and visual indication; and determine based on the sensor data and the operational parameters whether new flow control instructions need to be performed and if so, send the new flow control instructions to the flow control module.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 is a block diagram of a shower management system in accordance with an example embodiment;

FIG. 2 illustrates examples of user control interfaces on an example communication device such as a smart phone or tablet computer;

FIG. 3 illustrates an example user control interface corresponding to a user interface module;

FIG. 4A illustrates an example circuit diagram illustrating control of a light array with a demultiplexer;

FIGS. 4B, 4C, 4D, and 4E illustrate example implementations of a light array for the shower management system;

FIGS. 5A and 5B illustrate example implementations of water temperature sensors;

FIGS. 5C, 5D, and SE illustrate example implementations of water flow sensors;

FIG. 6 is a flowchart illustrating a method where user interface module, processor and flow control module interact in accordance with an example embodiment;

FIG. 7 is a flowchart of a method of controlling water flow to prevent scalding and thermal shock in accordance with an example embodiment;

FIG. 8 is a flowchart of a method of “pre-heating” water in accordance with an example embodiment;

FIG. 9 is a flowchart of a method of monitoring shower duration in accordance with an example embodiment;

FIG. 10 is a flowchart of a method of using voice control to interact with a shower management system in accordance with an example embodiment; and

FIGS. 11A and 11B illustrate example devices for generating power from water flow through a shower head assembly.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity.

### Description of Various Embodiments

The various embodiments described herein generally relate to methods (and associated systems configured to implement the methods) for managing the operation of a shower.

Various apparatuses or methods will be described below to provide an example of an embodiment of the claimed subject matter. No embodiment described below limits any claimed subject matter and any claimed subject matter may cover methods or apparatuses that differ from those described below. The claimed subject matter is not limited to apparatuses or methods having all of the features of any one apparatus or methods described below or to features common to multiple or all of the apparatuses or methods described below. It is possible that an apparatus or methods described below is not an embodiment that is recited in any claimed subject matter. Any subject matter disclosed in an apparatus or methods described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal or a mechanical element depending on the particular context. Furthermore, the term “communicative coupling” indicates that an element or device can electrically, optically, or wirelessly send data to another element or device as well as receive data from another element or device.

It should, also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware, software, or both hardware and software. In some cases, the example embodiments described herein may be implemented, at least in part, by using one or more computer programs, executing on one or more programmable devices comprising at least one processing element or executing on one or more integrated circuit elements, and a data storage element (including volatile and non-volatile memory and/or storage elements). These devices may also have at least one input device (e.g. a microphone, sensor, button, switch, keyboard, mouse, a touchscreen, and the like), and at least one output device (e.g. a display screen, a speaker, lights, a printer, a wireless radio, and the like) depending on the nature of the device.

It should also be noted that there may be some elements that are used to implement at least part of one of the embodiments described herein that may be implemented via software that is written in a high-level procedural language such as object oriented programming language. Accordingly, the program code may be written in C, C⁺⁺, Java, or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc, Secure Digital (SD) card, and micro Secure Digital (SD) card) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, Internet transmissions (e.g. downloads), media, digital and analog signals, and the like. The computer useable instructions may also be in various formats, including compiled and non-compiled code.

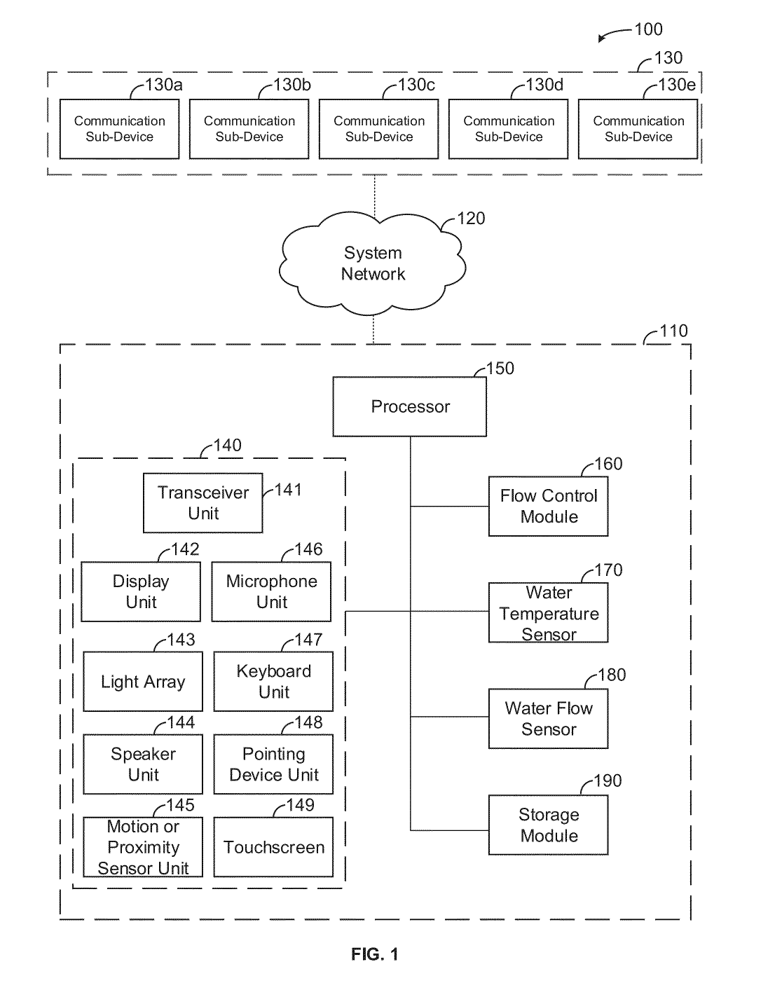

Reference is first made to FIG. 1, which shows a block diagram 100 of components interacting as part of a shower management system in accordance with an example embodiment. As shown in FIG. 1, a shower management system may include a communication device 130 and a shower management unit 110. In an example, a communication device 130 may include one or more than one communication sub-devices 103a to 103e. The communication device 130 may communicate with the shower management unit 110 via system network 120.

In an example, the shower management unit 110 may be implemented within a showerhead assembly. When implemented within a shower head assembly, electrical components within the showerhead assembly of the shower management unit 110 are isolated from the mechanical components. A shower management unit 110 implemented within a showerhead assembly does not perform any modifications to existing watery supply pipes or existing water supply valves. In an example, the shower management unit 110 may only monitor and affect shower characteristics such as water temperature and water flow rate near the output of the shower head assembly.

In another example, the shower management unit 110 may be integrated with water supply pipes, valves, and associated plumbing components. When integrated with water supply pipes, valves, and associated plumbing components, the shower management unit 110 may monitor and affect shower characteristics such as water temperature and water flow rate at the water supply source.

In yet another example, the shower management unit 110 may be implemented as an intermediary device that connects between an existing showerhead assembly and the water supply pipe to which it connects. In some embodiments, a showerhead management unit 110 implemented as an intermediary device does not perform any modifications to existing shower heads, nor does it perform any modifications to existing water supply pipes or existing water supply valves. In an example, the shower management unit 110 may only monitor and affect shower characteristics such as water temperature and water flow rate as the water flows through the intermediary device near the input of the shower head assembly.

System network 120 may include any network capable of carrying data between a communication device 130 and the shower management unit 110. System network 120 may be wired or may include one or more wireless communication networks, such as Wireless LAN (WLAN), a network implemented using Bluetooth® technology, Wireless Fidelity (Wi-Fi), infrared light, and other networks implemented using similar protocols and technologies.

System network 120 may facilitate communication between a shower management unit 110 and a communication device 130 that is outside the range of a wireless network. For example, system network 120 may include the Internet, Ethernet, plain old telephone service (POTS) line, public switch telephone network (PSTN), integrated services digital network (ISDN), digital subscriber line (DSL), coaxial cable, fiber optics, satellite, SS7 signaling network, Universal Serial Bus, and others, including any combination of these.

The communication device 130 may be a communication device dedicated for use with the shower management unit 110. The communication device 130 may be mounted or affixed near the shower management unit 110. In another example, the communication device 130 may be an electronic tablet device, a personal computer, workstation, portable computer, mobile device, personal digital assistant, laptop, smartphone, an interactive television, gaming system, and other portable electronic devices. The communication device 130 may include any computing device with at least a processor and memory and capable of receiving, sending, and processing instructions associated with the operation of the shower management unit 110. Alternatively, communication device 130 may include a computing device capable only of running software specific to the operation of the shower management unit 110. In a further example, the communication device 130 may be passive equipment capable of only providing and receiving fixed signals or selections to and from the shower management unit 110.

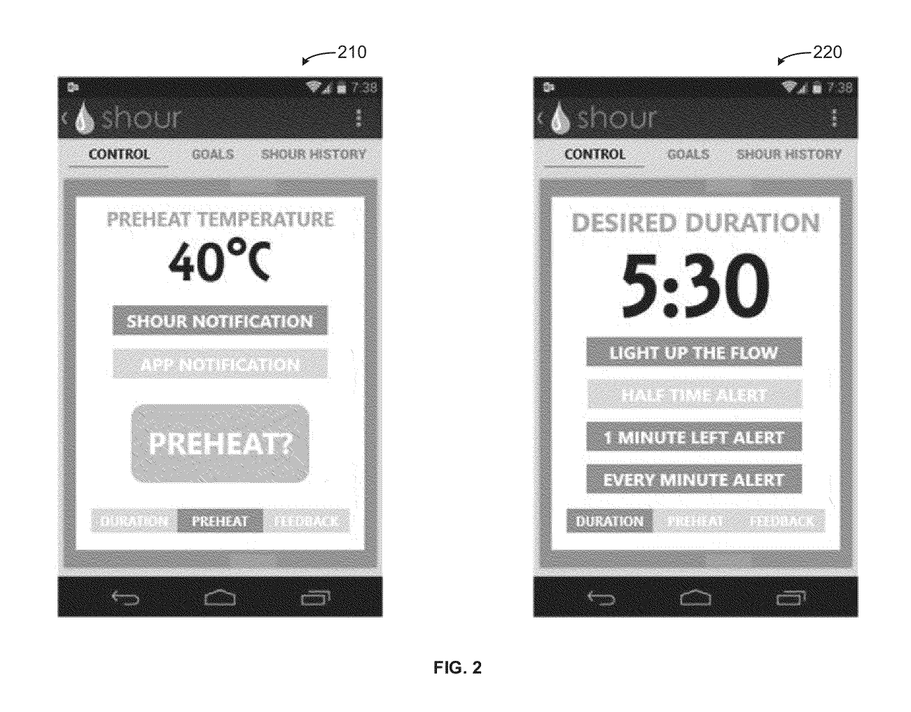

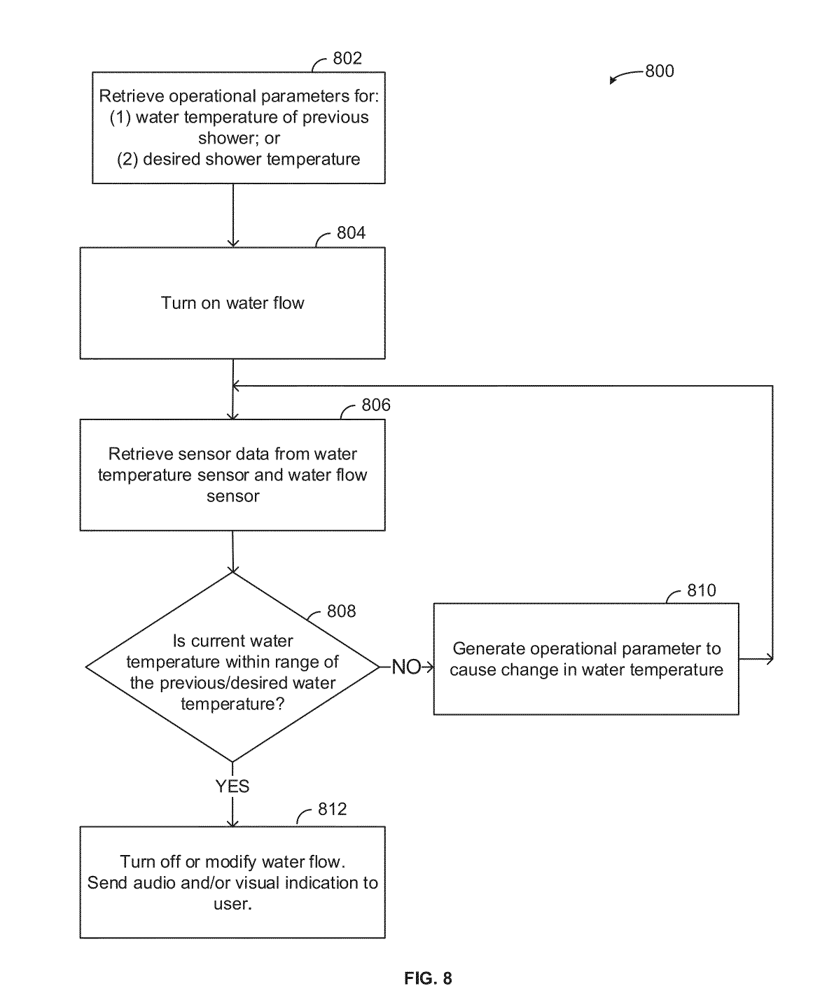

Communication device 130 may provide a user control interface allowing a user to provide inputs to user interlace module 140 of shower management unit 110. Example user control interfaces for a communication device 130 are illustrated in FIG. 2. In an example, a preheat user control interface 210 enables a shower user to remotely set the water temperature prior to entering the shower. “Pre-heating” water will be discussed in further detail having regard to FIG. 8.

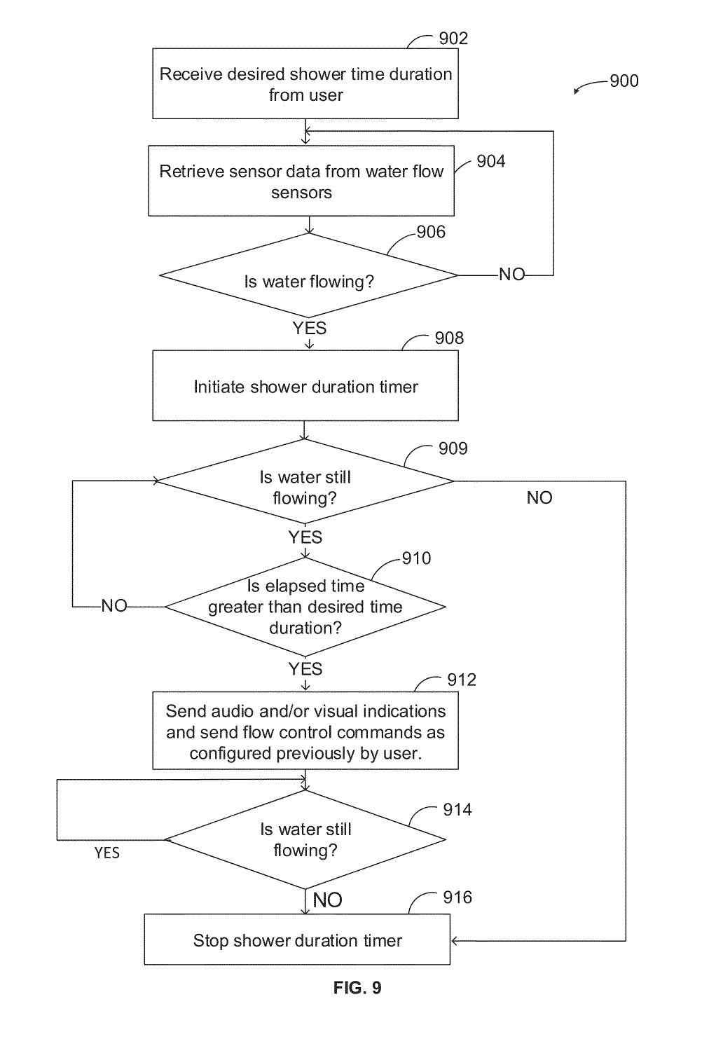

In another example, a shower duration user control interface 220 allows a shower user to setup a shower duration timer and several alert mechanisms (e.g. lights, sounds, flow rate modification, temperature modifications). The shower duration timer features will be discussed in further detail having regard to FIG. 9.

As described, any interaction between the shower management unit 110 and a communication device 130 may be based on a wired or wireless communication protocol.

Referring again to FIG. 1, shower management unit 110 includes a user interface module 140, a processor 150, a flow control module 160, at least one water temperature sensor 170, at least one water flow sensor 180, and at least one storage module 190.

User interface module 140 may provide a user control interface for receiving user inputs for operating the shower management unit 110 and transmitting audio, visual, or audio and visual indications to the user. User interface module 140 may include a wired, wireless, or wired and wireless combination transceiver unit 141, a display unit 142, a light array 143, a speaker unit 144, a motion or proximity sensor unit 145, a microphone unit 146, a keyboard unit 147, a pointing device unit 148, a touchscreen 149, and miscellaneous buttons and switches.

Transceiver unit 141 can act as a communication interface for shower management unit 110. In an example, the transceiver unit 141 may act to send and to receive wireless signals through system network 120 to a communication device 130. In another example, the transceiver unit 141 may include connection ports for facilitating transfer of data to and from a communication device 130 or a user control interface. The connection ports may include communication protocols such as Universal Serial Bus (USB) interface. Transceiver unit 141 may consist of any combination of a Bluetooth transceiver module, WiFi transceiver module, and radio transceiver module. Transceiver unit 141 may provide flexibility as to how a user may interact with the shower management unit 110. A user may, for example, provide operational parameters to shower management unit 110 with a communication device 130 such as a mobile device while the user is painting a backyard fence or is in a kitchen making breakfast and where a user is looking to prepare a shower with the user's preferences immediately upon finishing painting or cooking.

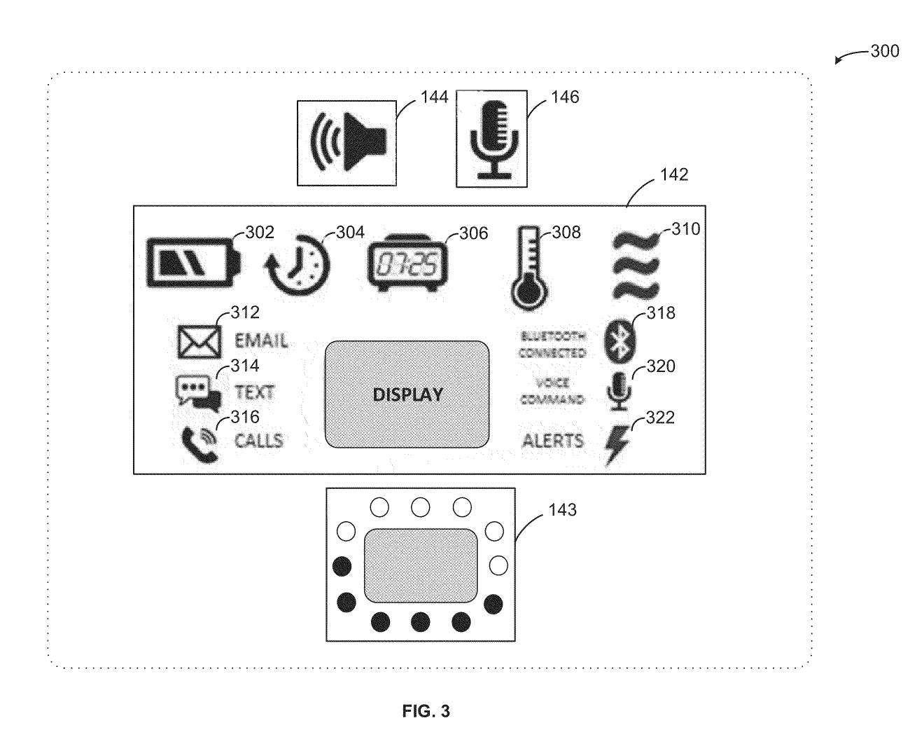

An example user control interface 300 corresponding to a user interface module 140 is illustrated in FIG. 3. User control interface 300 may be implemented in a communication device 130 dedicated for use with the shower management unit 110.

Display 142 may be used for displaying various graphics, text, or any combination thereof relevant to the operation of the shower management unit 110. In an example, display 142 may be an OLED display, LCD display, seven-segment display, or any other display technology capable of displaying any combination of graphical icons, alphanumeric information, images, and video. Examples of graphical icons include battery level icon 302, timer icon 304, clock icon 306, temperature icon 308, and water flow rate icon 310. The graphical icons may provide real-time information to a user (e.g. the elapsed time of the shower, the current water temperature, and the current flow rate).

In another example, the display 142 may be a touchscreen 149 allowing a user to interact with the shower management unit 110 through interactive touch by a user's fingers. It will be understood that the various graphical icons or textual information prompts may include a greater number or lesser number of graphical icons or textual information prompts and that the graphical icons or textual information prompts may be different than those illustrated in FIG. 3.

Light array 143 may include one or more discrete light emitting diode (LED) devices, and may include one or more devices using other light emitting technologies. Light array 143 may include discrete lights having properties including distinct colours, multi-colour capabilities, distinct light emitting intensity capabilities, or flashing patterns with varying flashing frequencies. Light array 143 may be used to visually alert a user of prescribed or use programmable indications. Examples of indications include warning alerts or shower management unit 110 system status information. Alternatively, light array 143 may reinforce information shown by graphical icons or textual information already shown on the display 142.

In an example, one discrete light may be used to denote a specific unit of time and a light array 143 may be used to indicate the amount of time that has elapsed. For example, a user may desire to limit their shower time duration to 10 minutes. If a light array was made up of 10 lights, the lighting of each discrete light may represent the passage of one minute. Alternatively, if a light array was made up of 5 lights, each discrete light may represent two minutes. When a shower has begun, each of the 10 lights may be deactivated. For each minute that passes, one light may be illuminated thereby indicating to the user the amount of elapsed time and also the approximate allotted time remaining for the shower.

In another example, the light array 143 may be used to provide alerts to the user. For example, light array 143 may be programmed to illuminate in red colour, indicating that a user selected water temperature has not been attained. Light array 143, for example, may be programmed to illuminate in green colour when the water temperature has reached a user selected temperature and to signal that a user may now enter the shower.

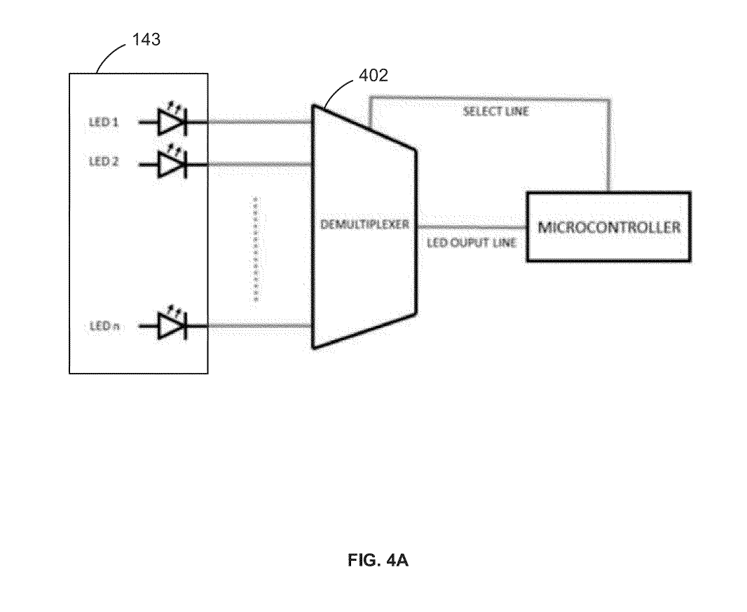

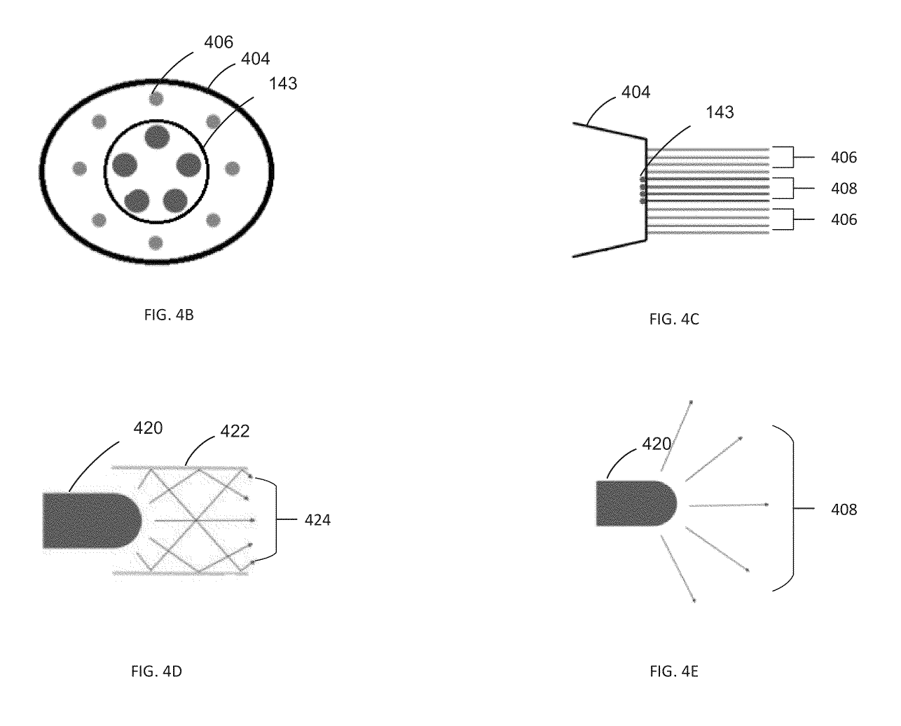

In an example where a shower management unit 110 is implemented within a shower head assembly, water output ports 406 may surround a light array 143 in a circular pattern. As illustrated in FIGS. 4B and 4C, showerhead assembly 404 may integrate water output ports 406 and a light array 143 within the same structure.

FIG. 4B illustrates an example showerhead assembly when seen by a shower user standing directly below the showerhead assembly. Water output holes 402 form a circular pattern around a light array 143.

FIG. 4C illustrates a side view of an example showerhead assembly. When water flows through the showerhead assembly, streams of water 406 may surround rays of light 408 emitted by light array 143.

Referring now to FIGS. 4D and 4E, a light within a light array 143 may be configured to disperse or focus emitted light rays. In an example, FIG. 4D illustrates an LED 420 positioned near several reflective surfaces 422. The resultant light emission 424 may be focused or re-directed to particular areas of a shower. In another example, FIG. 4E illustrates an LED 420 positioned in an open area and without any reflective surfaces.

It will be appreciated that while light array 143 has been described as being implemented with discrete lights, it should be understood that light array 143 may also be implemented by any other light source device capable of providing visual indications to a user, including discrete lights in other configurations. For example, multiple discrete lights may be placed behind an opaque material to produce the effect of lighted sections.

Referring to FIG. 4A, light array 143 may be controlled with a demultiplexer 402. Demultiplexer 402 may be used to selectively activate discrete lights within light array 143. If multiple discrete lights of the light array 143 are to be illuminated concurrently, the demultiplexer 402 may rapidly cycle through multiple discrete lights of the light array 143 to provide a user with the appearance that multiple lights of the light array 143 are illuminated simultaneously. In some embodiments, this is used to drive a large number of lights with a small number of processor outputs, thereby reducing the processor requirements. The demultiplexer 402 may be capable of operating at frequencies to cycle through the light array 143 such that the human eyes are unable to notice that the lights of light array 143 are being rapidly turned on and off.

Speaker unit 144 may include any device capable of receiving an electronic signal, vibrating in accordance to the electronic signal, and producing audible sounds to a user. In an example, the speaker 144 may be used to produce an audible tone to signal or alert that the water is currently extremely cold or extremely hot and that the user should wait for the water flow to reach the user selected temperature. In another example, the speaker 144 may be setup to playback media, such as music or the radio, for the duration of time the shower is operating or provide information such as voice readouts of the current water temperature, the current time, or received messages. Speaker unit 144 may also include a buzzer, such as a piezoelectric buzzer, to produce audio output.

In some examples, audio prompts in the form of tones or combination of tones may be produced by sending square voltage waves to the speaker 144 with a particular duty cycle and a particular frequency. A square voltage signal with 50% duty cycle having a 262 Hz frequency may produce a tone corresponding to a middle C tone. A lookup table of duty cycle and frequencies corresponding to audio tones may be stored within storage module 190.

A shower user may configure and define through the user interface module 140 the meaning of tones and associate meaning to specific time durations and volume of tones, as well as various patterns of tones. For example, a shower user may configure a 3 second audio tone at one half of the maximum speaker volume to represent that the pre-selected shower time duration has been reached. In another example, a shower user may configure a one second audio tone at one quarter of the maximum speaker volume to represent that half the pre-selected shower time duration has been reached. In a further example, a shower may configure an alternating on, off, and on again audio tone at the maximum speaker volume to represent that a thermal shock event is imminent, where the water temperature will rapidly change.

Shower management unit 110 may store pre-recorded audio files within storage module 190, Pre-recorded audio files may provide phrases such as “The current water temperature is 37 degrees Celsius.”

In some examples, a processor 150 may only be capable of processing and playing back audio data with limited audio bit depth. Processor 150 of a shower management unit 110 may be capable of converting pre-recorded audio files from a higher bit depth (e.g. 16-bit stereo) to pre-recorded files with an audio bit depth in the range of 8 to 19 kHz. In some examples, processor 150 conversion of pre-recorded audio files may be stored in storage module 190 or be transmitted to a communication device 130 for storage.

In another example, processor 150 may be capable of playing audio, such as music, on speaker 144 that is stored on an external communication device 130 such as a smartphone or laptop computer. This audio data may be transferred from the communication device 130 to the shower management unit 110 through system network 120 using a wireless protocol such as Bluetooth and/or Wi-Fi. The shower management unit 110 can receive this audio data at transceiver unit 141, process it at processor 150 and finally playing it on speaker 144.

Motion or proximity sensor unit 145 may be programmed to receive proximity data relating to distance between a user and a showerhead of the shower management unit 110. Motion or proximity sensor unit 145 may consist of light and other optical sensors, ultrasonic sensors, and infrared sensors among other such technologies. In an example, the proximity data may be utilized by shower management unit 110 to determine whether a user is within the range of a showerhead stream of water. If a user, for example, moves relatively far from the showerhead when lathering shampoo or soap, shower management unit 110 may be programmed to reduce the water flow rate or may be programmed to temporarily halt the water flow. Reduction of the water flow rate or temporarily halting water flow when a user is not in the direct path of a stream of water contributes to water conservation initiatives.

In another example, motion or proximity sensor unit 145 may be used as a means of user input. In an example, a user may wave their hand in front of a motion and/or proximity sensor in order to produce a preprogrammed change in water flow and/or temperature. Using sensing technology in this manner can provide a hands-free input method to shower management unit 110, which may reduce user effort and increase the likelihood that the user partakes in and applies water and energy conservation initiatives.

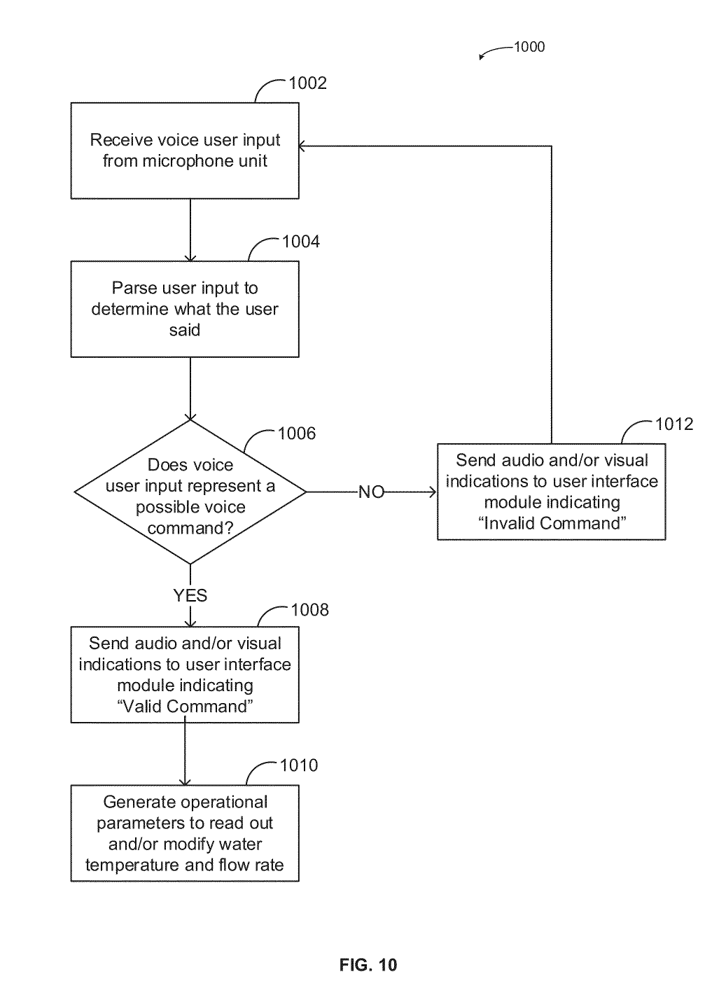

Microphone unit 146 may be setup to receive voice commands from a shower user. In an example, voice commands may include instructions to temporarily stop water flow, increase or decrease water temperature by a fixed number of degrees, or set a time based alarm to alert a user after a specific duration of time has elapsed. Providing a user with an ability to provide hands free user input to the shower management unit 110 may increase the likelihood that a user partakes and applies water and energy conservation initiatives. Methods of using voice control to interact with shower management unit 110 will be discussed in further detail having regard to FIG. 10.

In another example, microphone unit 146 may be used to receive voice recordings from the shower user. The user may use some input to initiate a recording, such as pushing a button, triggering a motion or proximity sensor 145, and/or speaking a predetermined initialization phrase such as “begin recording”. Upon initialization, the user's speech can be received by the microphone unit 146 and sent to the processor 150. The processor 150 may then transmit this audio recording to an external communication device 130, such as a smart phone, using transceiver unit 141 to transmit this data over system network 120. Alternatively, the processor 150 may store the audio data temporarily in storage module 190, and transmit it to an external communication device 130 at a later point in time. In an example, microphone unit 146 may be used by the user in such a manner to make note of ideas they may have while showering, or to create to do lists or set reminders for future tasks.

In the implementation of microphone unit 146, the audio input may be passed through various electronic filters and amplifiers prior to input into processor 150. In an example, a filter may be used to eliminate or allow particular frequencies that correspond to the constant background noise produced by the sound of the falling water or human speech, respectively, improving the clarity of the user's speech received by the processor 150.

Keyboard unit 147 may provide an interface containing alphanumeric characters. In an example, standalone keyboard unit may be mounted in close proximity to the shower management unit 110 to allow a user to input data consisting of user preferred settings or other operational parameters. In some examples, the keyboard unit 147 interface may consist of a QWERTY keyboard or a number pad, while in other examples, the keyboard unit 147 interface may only consist of limited characters.

Pointing device unit 148 may correspond to a pointing device as an additional mechanism for a user to interact with shower management unit 110. In an example, a pointing device may be a pen-like device that may be used to interact with a touchscreen 149 in a user control interface 300 illustrated in FIG. 3.

Additional input elements in user interface module 140 may include standard buttons and switches. For example, a switch may be used to control the power to the system, to turn it on and off, or to switch between the preferences and settings of different users. In another example, a button may be present for emergency or back up shut off of the water flow in the event of failure of other user input methods, such as the voice recognition.

Processor 150 may implement the various methods described herein. In an example, processor 150 may receive, via the transceiver unit 141 over system network 120, operational parameters from a communication device 130 and transmit operational parameters to storage module 190. Based on at least the received data and data stored at storage module 190, processor 150 may generate a plurality of additional operational parameters. Operational parameters may include minimum temperature settings, maximum temperature settings, user preference settings, and/or time duration settings. Processor 150 may also transmit data to communication device 130 via transceiver unit 141 over system network 120. In an example, processor 150 may send data regarding the user's latest shower to a communication device 130, which may be a smartphone, which then can prepare statistics and graphics on a mobile application to display to the user to inform them about their shower and showering habits. These statistics and graphics may include information about the length of the shower, the average temperature, the water usage, the energy usage, the monetary cost of the shower, as well as trends in these parameters over time. This information may encourage users to make changes to reduce wasteful behavior.

In another example, processor 150 may receive sensor data from a water temperature sensor 170 or from a water flow sensor 180 and may subsequently send sensor data to storage module 190. In a further example, processor 150 may generate operational parameters based on received sensor data from water temperature sensors 170 and water flow sensors 180 and transmit operational parameters to a flow control module 160 and user interface module 140.

In addition to sensor data, processor 150 may receive various forms of user input data from the user interface module 140. Processor 150 may parse this user input, store the information in storage module 190, transmit it to communication device 130 via transceiver unit 141 over system network 120, as well as generate operation parameters for controlling flow control module 160 and user interface module 140.

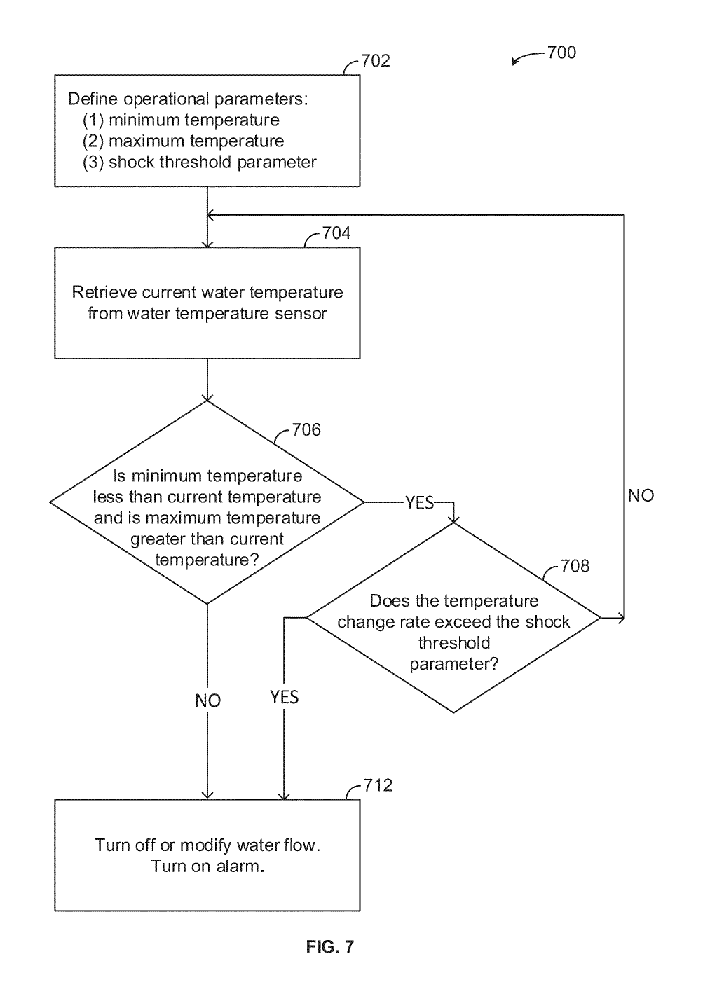

Flow control module 160 may perform the methods described herein. Flow control module 160 may govern the water flow rate of the shower management unit 110 to prevent scalding or thermal shock, to ensure the water temperature is at a desired temperature before a user positions his/herself within a stream of water, or to determine when water flow is to start or stop. Methods corresponding to flow control module 160 will be discussed in further detail having regard to FIGS. 7 to 10.

Water temperature sensor 170 may provide water temperature data to processor 150 for determining the current temperature of water exiting a shower head receptacle. In an example, water temperature sensor 170 may provide temperature data to the processor 150 at the instance of a specific request from processor 150. Alternatively, water temperature sensor 170 may continuously provide temperature data on fixed intervals to the processor 150 for generating shower operational parameters.

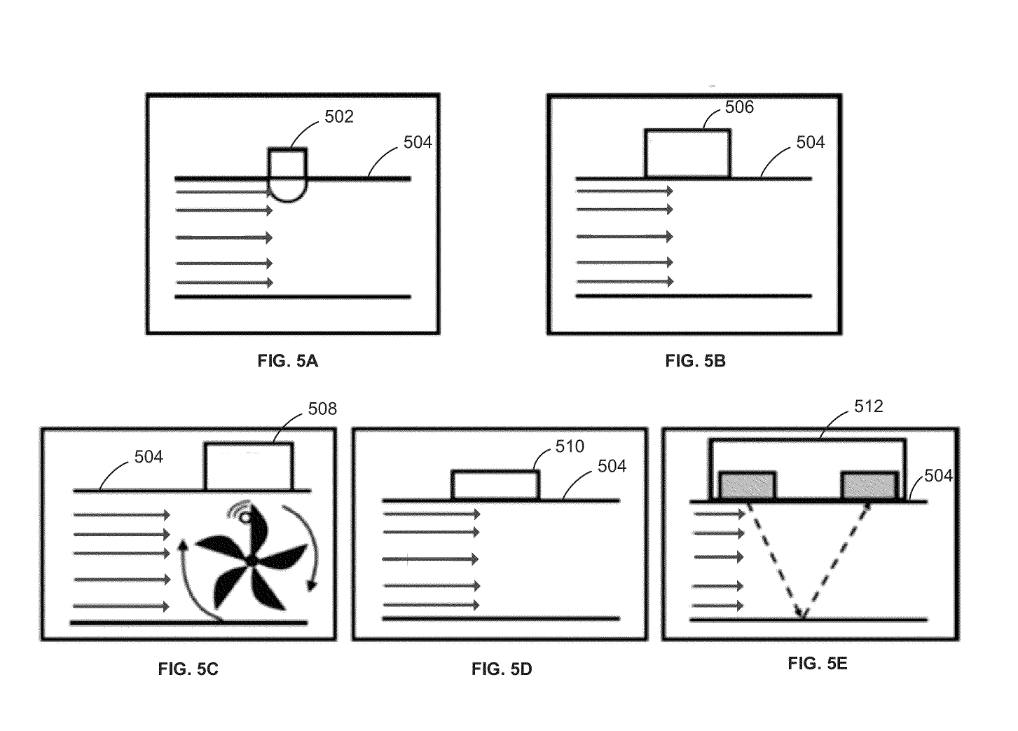

Referring to FIG. 5A, water temperature sensor 170 may include a thermistor 502. A thermistor 502 is commonly a resistive element where resistance across the thermistor 502 varies as temperature varies. In an example, a thermistor 502 may be positioned near a channel 504 of water flow and may detect thermally conducted temperature levels and changes. Alternatively, a thermistor 502 may be positioned within a channel 504 of water flow, and be mechanically isolated from other electrical components of the water temperature sensor 170 for waterproofing. Although the resistance of a thermistor in a water temperature sensor 170 may not necessarily vary linearly with temperature, a water temperature sensor 170 may be calibrated to provide a digital signal that can be mapped to a specific temperature by processor 150 based on known temperature characteristics of the thermistor.

Referring to FIG. 5B, water temperature sensor 170 may include a temperature sensing integrated circuit device 506. A temperature sensing integrated circuit may be configured to provide an output voltage value in response to a sensed temperature. Water temperature sensor 170 may transmit an output voltage value to processor 150 to be stored in storage module 190, transmitted to mobile device 130, or for generating operational parameters to be transmitted for operations relating to flow control module 160 and display module 140. In this way, real time water flow regulation and information can be achieved and provided respectively.

Water flow sensor 180 may provide water flow data to processor 150 for determining the presence of water flow or for determining the rate at which water moves through a water channel. Water flow sensor 180 may provide a volumetric flow rate. Alternatively, water flow sensor 180 may provide a mass flow rate. Referring to FIGS. 5C, 5D, and 5E, water flow sensors 180 may be implemented with a Hall Effect sensor 508, a microphone 510, or an ultrasonic sensor 512, respectively.

In an example, a Hall Effect sensor 508 may be used to detect magnet movement in a channel 504 of water flow. A pinwheel with a magnet may be mounted within a stream of water flow and the rate at which the magnet passes the sensor may be correlated to water flow rate.

In another example, water flow sensor 180 may include a microphone 510 positioned adjacent a channel 504 of water flow. The microphone 510 may detect vibrations caused due to the water flow and data relating to vibration amplitude may be correlated to water flow rate.

In a further example, water flow sensor 180 may include an ultrasonic sensor 512 placed near a channel 504 of water. The ultrasonic sensor 512 may enable the measurement of the velocity of water based on the difference in speed of an emitted beam of ultrasound in the direction of and against the direction of the water flow.

In some examples, processor 150 may transmit data from water flow sensor 180 to storage module 190 for storage. Alternatively, processor 150 may generate operational parameters using water flow sensor 180 data and send operational parameters to flow control module 160 for real-time regulation of water flow, and to user interface module 140 for real-time notifications for the user.

Storage module 190 may store operational parameters received from communication device 130 or generated by processor 150 based on input data from motion or proximity sensor unit 145, microphone unit 146, keyboard unit 147, pointing device unit 148, touchscreen 149, and miscellaneous button and switches. In addition, storage module 190 may store sensor data generated by water temperature sensors 170 and water flow sensors 180. Operational parameters may include user provided information, processor 150 generated parameters based on user preferences, and/or processor 150 generated parameters based on water temperature sensor 170 and water flow sensor 180 data. In some examples, storage module 190 may interact with other storage devices to implement by a distributed storage system. The distributed storage system may involve storing sensor data or operational parameters on other devices communicating through system network 120. Storage module 190 may be implemented using an EEPROM integrated circuit, an SD card, a micro SD card, and/or other data storage technologies.

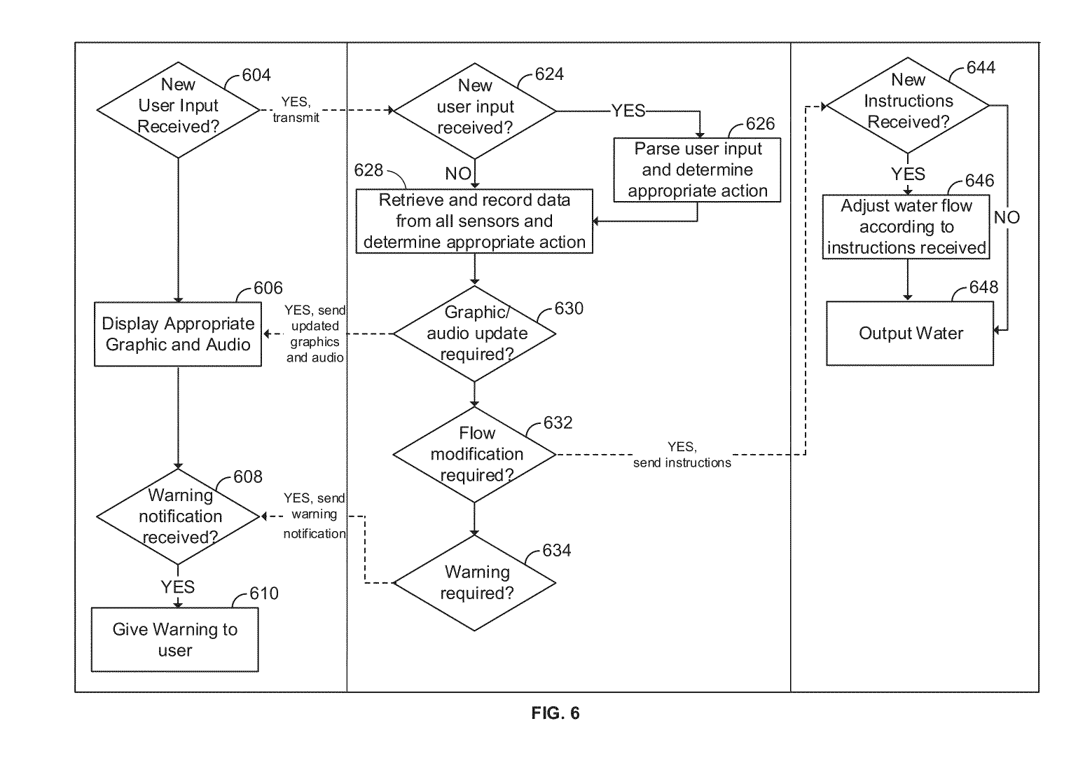

Reference is now made to FIG. 6, which is a flowchart diagram illustrating interaction between a user interface module 140, processor 150, and flow control module 160 in accordance with an example embodiment. At 604, a new user input may be provided by user control interface 300 or communication device 130. In an example, at 606, processor 150 may cause specific lights of a light array 143 to alter their state from on to off and vice versa, a display 142 to display new information to a user, or a speaker 144 to emit an audible tone or recording in response to changes in operational parameters such as the duration of the shower, the water flow rate and temperature, and user input. In other examples, processor 150 may not require any audio or visual indications. If a new user input is provided to user interface module 140, at 624, processor 150 receives the new user input. In some examples, the processor 150 may continuously and actively attempt to detect whether a new user input has been received. In other examples, the processor 150 may only operate in response to a user input that triggers the processor 150 to operate methods described herein.

At 626, processor 150 can parse new user input and determines an appropriate action to take, if any. At 628, processor 150 may retrieve and subsequently transmit to storage module 190 sensor data from some or a combination of water temperature sensors 170 and from some or a combination of water flow sensors 180. Processor 150 may be configured to continuously or periodically retrieve sensor data from water temperature sensors 170 and water flow sensors 180, or alternatively may only retrieve sensor data when prompted by a user input or as required by methods of flow control module 160.

In response to a new user input at 630, processor 150 may require that audio or visual indications of the user interface module 140 be updated. At 606, processor 150 may cause specific lights of a light array 143 to alter their state from on to off and vice versa, a display 142 or a touchscreen 149 to display new information to the user, or a speaker 144 to emit an audible tone or recording. These audio and visual indications may be used to pass information to the user, such as the shower duration or water temperature; they may also be used for alerts/notifications such as the water reaching a desired temperature or the passage of a particular amount of time, and they may also be used for acknowledging the receipt of a command/input. In other examples, processor 150 may require no change in audio or visual indicators of the interface module 140.

At 632, processor 150 can determine whether a water flow rate adjustment is required. For example, a water flow rate adjustment may be necessary where a user has exceeded a previously set shower duration time or where a user is no longer within the proximity of the shower or stream of water. If processor 150 determines that a water flow rate change is necessary, at 644, processor 150 generates operational parameters and sends operational parameters to flow control module 160.

At 646, processor 150 can cause flow control module 160 to adjust water flow in accordance with sent operational parameters. Flow control module 160 may be capable of controlling water flow by fully opening valves or fully closing valves. Alternatively, flow control module 160 may cause gradual or partial opening of water valves. Partially opening valves to different extents may make it possible to regulate the water flow rate to different levels. In an example, flow control module 160 may affect the operating state of two or more water supply pipes, such as a hot and a cold pipe. By controlling the extent that water valves are open, flow control module 160 may effectively govern the mixing of water from different supply pipes resulting in a desired water temperature and flow rate at the showerhead output. In another example, flow control module 160 may affect the operating state of a single valve present in or leading into the showerhead. By controlling the extent to which this valve is open, flow control module 160 may regulate the water flow rate at the showerhead output.

At 648, processor 150 can cause water to flow in accordance with new operational parameters.

At 634, processor 150 can determine whether an audible or visual warning is required. In an example, an audible or visual warning may be required if processor 150 determines that a sudden and significant change in flow is about to occur, such as if the user has set the shower temperature and/or flow rate to drop dramatically following the passage of a set period of time, or if the water temperature is about to suddenly change due to some change in the plumbing.

In an example, processor 150 may require an indication be sent to a user in response to increased water loading within a network of water supply pipes. For example, water pipes for a shower in a house may be connected to a larger network of water supply pipes. If someone in the house were to flush a toilet, the water flow rate of water pipes for a shower may experience a significant and sudden change in water flow rate and/or water temperature at the showerhead output. In this example, at 634, processor 150 may require that an audible or visual warning be given to the user, at 608, to provide advanced notice that the water temperature will significantly change and that the flow control module 160 may attempt to counteract the adverse temperature change. At 610, an audible or visual warning may be given. For example, light array 143 may produce flashing indicators and the speaker unit 144 may emit a high volume, pulsing audible tone to signal an unanticipated change in water temperature.

A flowchart 700 of an example method of controlling water flow to prevent scalding and thermal shock is shown in FIG. 7. At 702, processor 150 may generate operational parameters to be stored in storage module 190, or may retrieve previously stored operational parameters. Processor 150 may generate operational parameters based upon user inputs received from user interface module 140, operational parameters previously stored in storage module 190, or operational parameters generated by methods described herein.

At 702, processor 150 may define operational parameters such as a minimum water temperature parameter, a maximum water temperature parameter, and a shock threshold parameter. In an example where a user has not provided information for generating shower operational parameters, processor 150 may analyze water temperature records from previous showers to define operational parameters for preventing scalding and thermal shock. Processor 150 may consider data characteristics such as frequency of past shower water temperature values or running averages of past shower water temperature values to determine an initial water temperature range for the shower user. Processor 150 may also retrieve such information from a global database that collects and curates information from many shower control units. This information may be sent to processor 150 from a communication device 130 such as a smartphone, laptop, or personal computer that is capable of accessing the database and can wirelessly transfer the information to processor 150 via system network 120 using transceiver unit 141. Alternatively, Processor 150 may utilize a Wireless-Fidelity (Wi-Fi) module, which may be a part of the system network 120, to directly access this global database. Processor 150 may store this information in storage module 190, and may periodically update the stored information when new information is retrieved from the database.

Processor 150 may define various operational parameters or variables in determining whether a thermal shock scenario is imminent. In an example, processor 150 may define a “shock threshold temperature” to denote a maximum absolute value temperature change to trigger a thermal shock scenario. In addition, processor 150 may define a “shock threshold time” to denote a thermal shock scenario if the maximum absolute value temperature change defined by the “shock threshold temperature” occurred within the “shock threshold time.” In effect, a “shock threshold time” and a “shock threshold temperature” may collectively define a shock threshold parameter to represent an allowable maximum rate of temperature change before processor 150 triggers a thermal shock event.

In an example, processor 150 may define a “shock threshold temperature” to be 10 degrees Celsius. Further, processor 150 may define a “shock threshold time” to be 1 second. Collectively, processor 150 may define a shock threshold parameter of 10 degrees Celsius per second. In some embodiments, a change in water temperature at or above this rate would indicate a thermal shock scenario.

At 704, processor 150 can retrieve data from water temperature sensors 170 and water flow sensors 180 and may store the data in a storage module 190. Processor 150 may continuously retrieve data from water temperature sensors 170 and water flow sensors 180 at specific time intervals and utilize the sensor data to determine whether the shower is operating within defined operational parameters.

At 706, processor 150 can compare the current water temperature with both a defined minimum water temperature parameter and maximum water temperature parameter.

If the current water temperature corresponds to a value below a minimum water temperature parameter or to a value above a maximum water temperature parameter, at 712, processor 150 can generate operational parameters to cause flow control module 160 to counteract the undesirable water temperatures. In an example, processor 150 may turn off the water flow to prevent the user from encountering unacceptably cold water temperatures or encountering scalding hot water temperatures. In another example, processor 150 may generate and send operational parameters to the flow control module 160 to alter water supply pipe valve settings. The processor 150 may alter water supply pipe valve settings to attempt to return the water temperature to within the water temperature range defined by operational parameters; for example, if the water has turn cold then the amount of hot water being mixed may be increased, and vice versa.

At 708, processor 150 can compare the current rate of change in water temperature with a defined maximum rate of change in water temperature. Note that the rate of change may be compared in absolute terms, that is, irrespective of whether the temperature is increasing or decreasing, or alternatively the thresholds for positive and negative rates of change may differ.

In an example, a water temperature range may be defined broadly, for example, to be from 20 degrees Celsius to 40 degrees Celsius, and the shock threshold parameter may be 10 degrees per second. In some embodiments, if the water temperature were to change from 23 degrees Celsius to 35 degrees Celsius within one second, this would exceed the shock threshold parameter despite remaining within the water temperature range. Although a current water temperature reading may lie within a water temperature range defined by operational parameters, a rapid change in water temperature over a short duration of time may unexpectedly catch a shower user by surprise and cause discomfort and may cause the user to suddenly react, which may result in an accident such as slipping and falling or hitting one's head. Such a scenario may occur, for example, when a network of water supply pipes experiences a sudden “water load”.

In the example discussed above, where processor 150 determines that the water temperature has significantly changed over a short duration of time (i.e. where water temperature has changed at a rate larger than 10 degrees Celsius per second), at 712, processor 150 may generate operational parameters for flow control module 160 to either counteract the rapid change in water temperature or shut off the flow of the water. Further, at 712, processor 150 may generate indications for user interface module 140 so that a user may be alerted of impending circumstances. The measures to counteract and alert a user of anticipated rapid changes in water temperature, for example, may be useful for preventing scalding or shock. Although this is beneficial for any user, it may be particularly useful when bathing a young child who may be more vulnerable to the effects of the water temperature or may be less able to remain calm and respond rationally.

In some embodiments, if at 708, processor 150 determines that the rake of change of temperature is less than the defined shock threshold parameter, processor 150 does not intervene.

The rate of change in temperature, regardless of whether it exceeds the defined thermal shock threshold parameter, may be recorded in storage module 190 and may be transmitted to an external communication device 130 via system network 120 for the purposes of data collection and analysis.

A flowchart 800 of an example method of “pre-heating” water temperature is shown in FIG. 8. It is often undesirable to enter a shower and find the water temperature extremely cold, or extremely hot. The example method of flowchart 800 may allow a user to remotely or automatically ensure the water temperature of a shower begins within a pre-defined temperature range.

At 802, processor 150 can retrieve a desired water temperature operational parameter value. A desired water temperature operational parameter value may correspond to the water temperature during a previous shower, or be calculated based on statistics from many previous showers. As an example, the desired temperature operational parameter may be calculated as the average water temperature from the user's previous 10 showers. Alternatively, a desired water temperature value may be defined based on user input from user interface module 140. The desired water temperature value may also be defined based on user input from an external communication device 130 that is transmitted to processor 150 by transceiver unit 141 via system network 120. For example, the user may remotely enter a desired water temperature using an application on a smartphone.

At 804, processor 150 can cause flow control module 160 to turn on the water flow.

At 806, processor 150 can retrieve sensor data from water temperature sensors 170 and water flow sensors 180. Sensor data may be used to determine whether the water temperature is within a defined temperature range, defined by operational parameters. In some embodiments, this is to ensure that a user does not encounter undesirable water temperatures when the user enters a shower or at the instance that water begins to flow from a shower head.

At 808, processor 150 can compare the current water temperature value with operational parameters corresponding to a desired water temperature. Flow control module 160 may complete “pre-heating” water when the current water temperature value corresponds to a defined desired water temperature value. Alternatively, flow control module 160 may complete “pre-heating” water when the current water temperature is approximately near a desired water temperature. In an example, if the desired water temperature is 35 degrees Celsius, processor 150 may determine that “pre-heating” water is complete when the current measured water temperature is within 2 degrees Celsius of the desired water temperature. In effect, flow control module 160 allows a user to remotely run cold water or hot water out of a pipe before they enter a shower. This saves time for the user, as they may no longer have to wait in person for the water to reach the desired temperature, and this can also prevent the water being run longer than necessary to purge the cold or hot water out of the pipes.

At 808, if processor 150 determines that the current water temperature is sufficiently near the desired water temperature, a signal can be sent to flow control module 160 at 812 to turn off the water flow, and an indication can be given to the user that the desired temperature has been reached. This indication may involve flashing lights in light array 143, producing audible tones on speaker unit 144, and sending a notification to an external communication device 130, such as a smartphone, using transceiver unit 141 via system network 120. The shutting off of the water flow at 812 may be beneficial for water conservation efforts. This is because users often have a tendency to run showers longer than necessary to purge the hot or cold that is present in the pipes, and consequently water of suitable temperature is wasted. With this system, the water flow may be immediately shut off when the desired temperature has been reached, reducing the possibility of waste. It is also noteworthy that because of the high specific heat capacity of water, once the desired water temperature has been reached, the temperature of the water can be expected to remain at approximately this level for some time, improving practicality in instances where the user does not immediately enter the shower even once the desired temperature has been reached.

If processor 150 determines that the current water temperature value is not within an acceptable water temperature range, at 810, processor 150 can generate operational parameters to cause flow control module 160 to affect changes in the water temperature. Flow control module 160 may affect changes in water temperature by adjusting a plurality of water valves in a network of water supply pipes. In an implementation in which the shower control system does not have control over the supply valves, preheating of the water may depend upon the user leaving the temperature control valves open upon completion of the shower. In this way, when the flow is restarted for the next shower, the temperature setting from the previous shower may remain. Flow control may be achieved by a valve present at the point of the showerhead, which makes it possible to control the flow without modifying the supply valves. In this scenario, when a user finishes showering, the supply and/or temperature valves can be left untouched and the flow can be stopped by the showerhead valve. In order to preheat the water, the flow may be reopened at the showerhead valve, and water may flow to achieve the temperature settings from the previous shower. Processor 150 may store the final temperature of the previous shower in storage module 190, and when it determines that the current water temperature value is within an acceptable water temperature range, at 808, processor 150 can generate operational parameters to provide indication to the user and to cause flow control module 160 to turn of the water flow.

In some examples, processor 150 may generate operational parameters to cause a flow control module 160 to operate for a fixed or limited duration of time. If shower management unit 110 is unable to reach a desired water temperature within a defined duration of time, processor 150 may generate indications for user interface module 140 to signal that there may be an issue relating to the network of water supply pipes preventing the shower from achieving a desired water temperature value. Fixing or limiting the duration of time for “pre-heating” may strike a balance between achieving a user's desired water temperature and conserving by preventing the potential for significant water wastage.

A flowchart 900 of an example method of monitoring shower duration in the shower management system 110 is shown in FIG. 9. At 902, processor 150 can retrieve from storage module 190 operational parameters relating to a user's desired shower duration. Alternatively, processor 150 may generate operational parameters based upon user input from user interface module 140, where a user has specified a desired shower time duration. In an example, the desired shower duration may be defined based on user input from an external communication device 130 that is transmitted to processor 150 via system network 120. For example, the user may remotely enter a desired shower duration using an application on a smartphone.

At 904, processor 150 can retrieve sensor data from water flow sensors 180. In an example, processor 150 retrieves sensor data to determine the presence of water flow through the shower head.

At 906, processor 150 can determine from the sensor data whether water is currently flowing in the shower. If processor 150 determines that water is not currently flowing in the shower, processor 150 may continuously retrieve sensor data from water flow sensors 180 at periodic time intervals and to monitor whether a user has begun to use the shower.

If processor 150 determines that water has begun flowing in the shower, at 908, processor 150 can initiate a shower duration timer to keep track of the shower duration.

At 909, processor 150 can determine from sensor data whether water continues to flow. If the shower user has finished showering and the water flow has been shut off, at 916, processor 150 can halt the shower duration timer.

On the other hand if, at 909, processor 150 determines that water continues to flow through the shower head assembly, at 910, processor 150 can determine whether an elapsed shower time duration has exceeded the desired shower time duration.

If the elapsed shower time exceeds a value corresponding to the desired duration of a shower, at 912, processor 150 may generate and send an indication to user interface module 140 to display audible and visual alerts relating to shower duration time limits. In an example, user interface module 140 may cause a countdown timer to be displayed to the user by using a light array 143 or through graphical, textual and/or audio prompts at user interface module 140. In further examples, processor 150 may send operational parameters to flow control module 160 to reduce water flow rate or to stop the water flow. Reducing water flow rate may provide direct feedback to the user that the desired shower duration has been exceeded and that, in the interest of conserving water, the user should attempt to finish the shower as soon as possible. The operational parameters generated by processor 150 upon exceeding the desired shower duration may be configured by the user. This may be done through user interface module 140 using a communication device 130 such as a smartphone.

At 910, if the elapsed shower time does not exceed a value corresponding to the desired duration of a shower, at 909, processor 150 can determine whether water is flowing through the showerhead assembly. Processor 150 may continually check whether water is still flowing through the showerhead assembly until the water flow has ceased or until the elapsed shower time is determined to exceed the desired shower duration.

At 912, after processor 150 generates indications for the user and may have generated flow control operational parameters to adjust water flow, at 914, processor 150 can continue to monitor sensor data to determine whether water is flowing through the showerhead assembly. In some examples, if the water flow has not ceased, processor 150 may cause further audio and visual indications to be sent to the flow control module 140.

At 916, processor 150 can halt the shower duration timer. The shower duration may be recorded in storage module 190 and may be transmitted to an external communication device 130 via system network 120 for the purposes of data collection and analysis. This information may also be transmitted to and stored on an online database using a Wireless-Fidelity (Wi-Fi) module that may be a part of the system network. This data analysis may be used to assist the user in determining a desired shower duration. For example, the data analysis may be used to illustrate to the user how much water, energy and money they may save in one year by reducing their average daily shower duration by one minute. The data may also be contextualized for the user, for example, by illustrating water savings in more relatable terms, such as how many water bottles of water can be saved per shower as opposed to a quantity such as litres. A user's showering statistics can also be compared with those of other users and the general population. By collecting, analyzing and presenting data in this way, users can be shown the environmental, monetary, and long term implications of their showering habits, which may help to elicit change in behavior.

A flowchart 1000 of an example method of using voice control to interact with the shower management system 110 is shown in FIG. 10. At 1002, processor 150 can receive a voice user input. In an example, processor 150 may receive a voice user input from microphone unit 146 of user interface module 140. Alternatively, processor 150 may receive a voice user input from a communication device 130 operating with shower management unit 110 via system network 120.

At 1004, processor 150 can parse the received voice user input. In some examples, processor 150 may generate a data file representing the voice user input and send the data file to storage module 190. The voice user input may be parsed in a variety of ways. For example, the audio waveform of the voice user input may be compared with the waveforms of known phrases in order to establish a match. In another example, the voice user input may be transmitted by processor 150 using transceiver unit 141 via system network 120 to a communication device 130 such as a smartphone or computer with an application capable of parsing the voice input. The parsed information may then be transmitted back to the shower management system 110 by communication device 130 via system network 120. Many other algorithms and software also exist that may be used for parsing voice input.

Allowing a user to interact dynamically with shower management system 110 using voice empowers a user to more actively manage shower characteristics and preferences, including water flow rate and water temperature. In an example, a user may conveniently and dynamically instruct the shower management unit 110 to reduce water flow rate during times when water usage is non-critical, such as when the user is lathering shampoo and soap. In such a scenario, it may be inconvenient to adjust knobs, however, with voice input the user may control the shower characteristics hands free and without looking or touching anything, Leaving water running in instances when it is not necessary due to inconvenience is a significant contributor to shower water wastage, which may be reduced with this shower management system.

At 1006, processor 150 can determine whether a voice user input represents a possible voice command that may be accepted by the shower management unit 110. In some examples, processor 150 may compare the received voice user input data with an accumulation of data files representing pre-programmed commands stored in storage module 190.

If at 1006 processor 150 determines that a received voice user input represents a command that processor 150 may execute to generate operational parameters, then at 1008, processor 150 can send at least one audio and visual indications to user interface module 140 indicating that the received voice user input is valid.

In an alternative scenario, the voice user input may represent a command that requires processor 150 to generate operational parameters for user interface module 140. For example, the user may request to know the current water temperature, in response to which processor 150 may give an audio readout of the temperature via speaker module 144.

In some embodiments, if the identified voice command requires modification of the shower characteristics, such as a change in water flow or temperature, then at 1010, processor 150 generates and provides operational parameters to flow control module 160 to affect the shower characteristics. In an alternative scenario, if the identified voice command requires further user interaction, then at 1010, processor 150 generates operational parameters for user interface module 140 to display information or manage further user interactions.

In an example, if a shower user vocalized the command “the water is too cold,” at 1010, processor 150 may generate operational parameters for flow control module 160 to increase the water flow rate of a hot water supply pipe, decrease the water flow rate of a cold water supply pipe or both. In another example, the user may request to know the current water temperature by saying “how hot is the water?” in response to which processor 150 may give an audio readout of the temperature via speaker module 144 or the display unit 142.

At 1006, if processor 150 determines that a voice user input does not represent possible voice command that may be accepted by the shower management unit 110, at 1012, processor 150 may send at least one of an audio and video indication to the user interface module 140 to indicate that the received voice user input is an invalid command. At 1012, processor 150 may prompt the user to provide a new voice command. At 1002, processor 150 may then attempt to receive a voice user input. In order to prevent processor 150 from considering every voice user input to be a potential command, commands may be preceded by a particular phrase to uniquely identify commands from other audio input. For example, every voice command may be preceded by the phrase “Hey shower . . . ,”. This identifying phrase may be particularly useful if a user, for example, enjoys singing in the shower: the identifying phrase will prevent their singing from continually being perceived to be a voice command.

It will be appreciated that while flowchart 1000 describes a method of using voice control to interact with the shower management unit 110 with a pre-programmed number of acceptable shower commands, it should be understood that the method of using voice control to interact with the shower management unit 110 may be implemented to be dynamically programmable to accept new commands, to allow a user to train the shower management unit 110 to respond to commands, and to enable new ways to interact with the shower. It is also noteworthy that the voice control system may be configured to be used with other forms of audio input, such as clapping, whistling, etc.

Another application of voice input technology may be for the user to create audio recordings. The user may issue a voice recording command via user interface module 140: processor 150 may acknowledge this by sending an indication to user interface module 140. At this point the user may begin speaking and their voice input can be transmitted to processor 150 through microphone unit 146. This audio data may then be transmitted immediately to a communication device 130 such as a smartphone using transceiver unit 141 via system network 120, or it may be stored temporarily at storage module 190 and transmitted to a communication device 130 at a later point in time. The user may then retrieve their audio recordings from communication device 130 after completing their shower. The capability to create such recordings may be useful for users to keep track of thoughts they may have while showering, and may use it to set reminders, create to do lists, take note of ideas, etc.

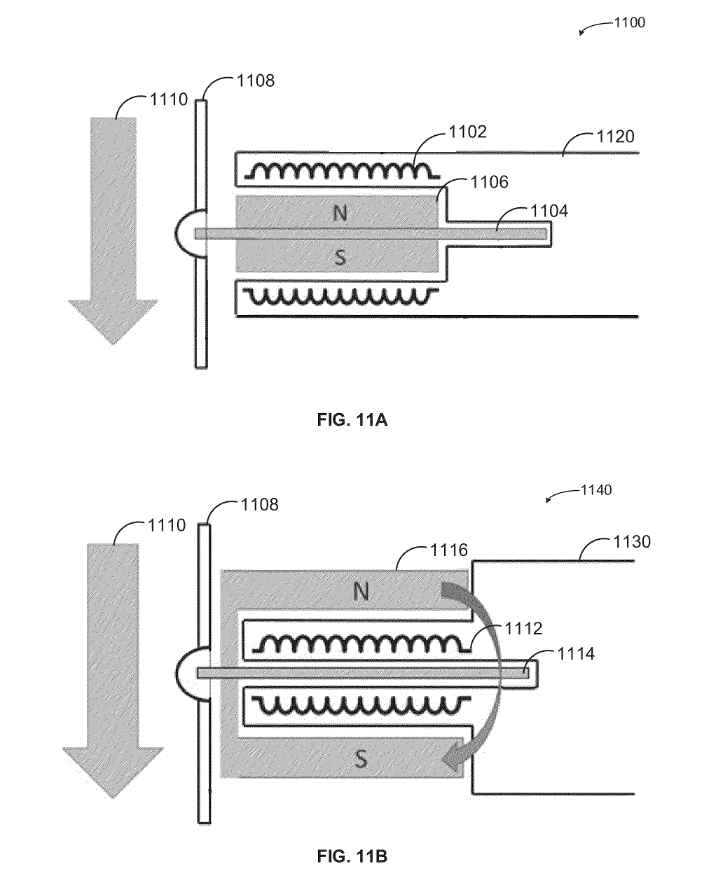

Reference is now made to FIG. 11A and FIG. 11B, which illustrate example devices for generating power from the water flow through a showerhead, Although the shower management unit 110 may be powered by a rechargeable or replaceable battery source, such as an off-the-shelf 9 volt battery, lithium polymer battery, or nickel metal hydride battery, power generated from water flow may be used to operate the shower management unit 110.

FIG. 11A illustrates an example inner magnet power generation device 1100 for generating power from water flow through a shower head assembly. Inner magnet power generation device 1100 may include coils of wire 1102, an axle 1104, permanent magnet 1106, a turbine 1108, a water channel 1110, and a water sealed enclosure 1120.

In an example, an axle 1104, a permanent magnet 1106, and a turbine 1108 may be operatively coupled to each other and may be completely immersed within a water channel 1110. Rotating the turbine 1108 may cause corresponding rotation of the axle 1104 and the permanent magnet 1106. The coils of wire 1102 may be enclosed within a water sealed enclosure 1120 and may remain stationary.

When water flows through water channel 1110 causes rotation of the turbine 1108, the permanent magnet 1106 may rotate on the axle 1104 and generate a change in magnetic flux through the coils of wire 1102. The change in magnetic flux results in the generation of electric current in the coils of wire 1102. The resultant electric current in the coils of wire 1102 may be utilized to power the shower management unit 110 or may be stored in a battery. The water sealed enclosure 1120 electrically isolates the coils of wire 1102 from the water channel 1110. Note that the water may flow parallel or perpendicular to the rotation of the turbine.

FIG. 11B illustrates an example outer magnet power generation device 1140 for generating power from water flow though a shower head assembly. Outer magnet power generation device 1140 may include coils of wire 1112, an axle 1114, a permanent magnet assembly 1116, a turbine 1108, a water channel 1110, and a water sealed enclosure 1130.

In an example, an axle 1114, a permanent magnet assembly 1116, and a turbine 1108 may be operatively coupled to each other and may be completely immersed within a water channel 1110. Similar to the water sealed enclosure 1120 of FIG. 11A, water sealed enclosure 1130 may electrically isolate coils of wire 1112 from other components of the outer magnet power generation device 1140. Water sealed enclosure 1130 is physically adapted to encapsulate coils of wire 1112 from the rotating permanent magnet assembly 1116.

Similar to FIG. 11A, when water flow through water channel 1110 causes rotation of the turbine 1108, the rotating permanent magnet assembly 1116 generates a change in magnetic flux through the surface area of the coils of wire 1112, resulting in electric current in coils of wire 1112.

It will be appreciated that while FIGS. 11A and 11B illustrate an inner magnet power generation device 1100 and an outer magnet power generation device 1140 for generating electric current through coils of wire 1102, 1112, it should be understood that the physical configuration of a permanent magnet assembly 1106, 1116, physical configuration of the water sealed enclosure 1120, 1130, and the physical placement of coils of wire 1102, 1112, may be implemented in any other physical configuration to allow turbine 1108 generated changes in magnetic flux to impart electric current through coils of wire 1102, 1112.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A method for managing the operation of a shower, the method comprising:
a) receiving user input through at least one input channel;
b) optionally generating a first indication at a user interface module comprising at least one of an audio and visual indication;
c) optionally executing at least one of a plurality of flow control instructions at a flow control module; and
d) providing and configuring a processor, operatively coupled to the user interface module, the flow control module, at least one of a plurality of sensors, and a storage module, to:
i. receive the user input from the user interface module;
ii. receive sensor data from the at least one of a plurality of sensors;
iii. store the sensor data at the storage module;
iv. process the user input and sensor data, and generate at least one of a plurality of operational parameters;
v. transmit and receive information to and from communication devices via a system network;
vi. determine based on the sensor data and the operational parameters whether a second indication is needed, and if so, causing the user interface module to optionally generate the second indication comprising at least one of an audio and visual indication; and
vii. determine based on the sensor data and the operational parameters whether new flow control instructions need to be performed, and if so, sending the new flow control instructions to the flow control module.

2. The method of claim 1, wherein the user input is obtained from at least one of a wireless device, a microphone coupled to the user interface module, a motion or proximity sensor coupled to the user interface module, a pointing device, a keyboard, and a touchscreen.

3. The method of claim 1, wherein the processor is further configured to:
generate operational parameters defining a minimum temperature threshold, a maximum temperature threshold, and a shock threshold;
continually receive temperature sensor data from at least one water temperature sensor;
determine a current water temperature based on the temperature sensor data;
determine a temperature change rate based on the temperature sensor data;
determine whether the current water temperature is less than the minimum temperature threshold or greater than the maximum temperature threshold; and
determine whether the temperature change rate exceeds the shock threshold.

4. The method of claim 3, wherein if the current water temperature is less than the minimum temperature threshold or greater than the maximum temperature threshold, or if the temperature change rate exceeds the shock threshold, the processor is further configured to:
generate and send operational parameters to the flow control module, which comprises at least one of shutting off the water flow, reducing the water flow, adjusting flow control valves to alter the water temperature, and generating at least one of an audio and visual indication for the user interface module.

5. The method of claim 1, wherein the processor is further configured to:
determine a user desired shower temperature based on operational parameters of at least one of a previous shower, aggregate data from previous showers, aggregate shower data from multiple users, and the user input;
send instructions to the flow control module to initiate water flow;
receive sensor data from at least one water temperature sensor, the sensor data being utilized to determine the current water temperature; and
determine whether the current water temperature is within a user desired shower temperature range;
i. if the current water temperature is within the user desired shower temperature range, send instructions to flow control module to turn off water flow and generate at least one of an audio and visual indication for the user interface module and external communication devices;
ii. if the current water temperature is not within the user desired shower temperature range, generate operational parameters to increase or decrease water temperature, or continue water flow to purge hot or cold water already present in the pipes.
wherein the user desired shower temperature range is a temperature greater than 10% above or below, or within a user specified number of degrees above or below the user desired shower temperature.

6. The method of claim 1, wherein the processor is further configured to:
determine a desired shower time duration using information from at least one of the user interface module and the data storage module;
retrieve flow sensor data from water flow sensors, and if flow sensor data indicates that water is flowing, initiate a shower duration time;
while flow sensor data indicates that water is flowing, determine whether elapsed shower time is greater than the desired shower time duration; and
if the elapsed shower time is greater than the desired shower time duration, generate and send operational parameters for at least one of an audio and visual indication to the user interface module and generate and send operational parameters to the flow control module.

7. The method of claim 1, wherein the processor is further configured to:
receive a voice user input from the user interface module;
parse the voice user input; and
determine whether the voice user input represents a possible voice command;
i. if the voice user input represents a possible voice command, send at least one of an audio and visual indication to the user interface module indicating a valid command, and generate operational parameters for at least one of the user interface module, flow control module, sensors and storage module based on the voice command;
ii. if the voice user input does not represent a possible voice command, send at least one of an audio and visual indication indicating an invalid command.

8. The method of claim 1, wherein the processor is further configured to:
receive user input from the user interface module to begin an audio recording;
generate and send instructions to the user interface module for at least one of an audio and visual indication indicating the initialization of a recording;
store the audio data from the user's voice at the storage module and transmit it to a communication device, and generate at least one of an audio and visual indication indicating that a recording is in progress;
receive user input from the user interface module to terminate an audio recording; and
stop storing and transmitting audio data and send instructions to the user interface module for at least one of an audio and visual indication indicating the completion of a recording.

9. A system for managing the operation of a shower, the system comprising:
a) a user interface module to receive user input through at least one input channel and optionally generate a first indication comprising at least one of an audio and visual indication;
b) a flow control module to execute at least one of a plurality of flow control instructions;
c) a processor, operatively coupled to the user interface module, the flow control module, at least one of a plurality of sensors, and a data storage module, configured to:
i. receive the user input from the user interface module;
ii. receive sensor data from the at least one of a plurality of sensors;
iii. store the sensor data at the storage module;
iv. process the user input and sensor data, and generate at least one of a plurality of operational parameters;
v. transmit and receive information to and from communication devices via a system network;
vi. determine based on the sensor data and the operational parameters whether a second indication is needed, and if so, causing the user interface module to optionally generate the second indication comprising at least one of an audio and visual indication;
vii. determine based on the sensor data and the operational parameters whether new flow control instructions need to be performed, and if so, sending the new flow control instructions to the flow control module.

10. The system of claim 9, wherein the system further comprises:
at least one of a showerhead assembly, a shower assembly, and an intermediary device; and
at least one of a replaceable battery, a rechargeable battery, and an electric generator.

11. The system of claim 9, wherein the data storage module further comprises:
operational parameters generated by the processor;
sensor data received from the at least one of a plurality of sensors;
plurality of possible indications displayable by the user interface module;
data for voice control commands, and
flow control instructions.

12. The system of claim 9, wherein the user interface module further comprises at least one of:
a wireless transceiver;
a display;
a light array;
a speaker;
a motion sensor;
a proximity sensor;
a microphone;
a keyboard;
a pointing device;
a touchscreen; and
a plurality of buttons and switches.

13. The system of claim 9, wherein the flow control module further comprises at least one of:
flow control valves;
sensors for monitoring the position of the flow control valves; and
motors and gearboxes for actuating the flow control valves.

14. The system of claim 10, wherein the system is implemented within a standard showerhead assembly including a water sealed enclosure and standard internal structures and water channels.

15. The system of claim 10, wherein the system is implemented within a shower assembly including a showerhead assembly, valves controlling water supply source pipes, and the surrounding knobs and face plates.

16. The system of claim 10, wherein the system is implemented within an intermediary unit fitting between a showerhead assembly and the water pipe to which the showerhead assembly connects.

17. The system of claim 9, wherein the plurality of sensors comprises at least one water temperature sensor and at least one water flow sensor.

18. The system of claim 10, wherein the electric generator comprises:
a turbine;
an axle;
a permanent magnet;
coils of wire; and
a water sealed enclosure.

19. The system of claim 9, wherein the visual indications are displayed on at least one of a display and an array of lights.

20. The system of claim 9, wherein the audio indications are emitted through a speaker.
